(19) United States
(12) Patent Application Publication
(10) Pub. No.: US 2007/0109230 A1
(43) Pub. Date: May 17, 2007

(54) Electron emission display device and method of driving the same

(76) Inventor: Mun Seok Kang, Anyang (KR)

Correspondence Address: CHRISTIE, PARKER & HALE, LLP, PO BOX 7068, PASADENA, CA, 91109-7068, US

(21) Appl. No.: 11/517,727

(22) Filed: Sep. 8, 2006

(30) Foreign Application Priority Data
Sep. 15, 2005 (KR) 2005-86542

(51) Int. Cl. G09G 3/22

(52) U.S. Cl. 345/74.1

(57) ABSTRACT

An electron emission display device for reducing or preventing non-uniformity in color from being generated due to a difference in brightness characteristics of red, blue, and green light components, and a method of driving the same. The display device includes: red, blue, and green pixels adapted to emit light in accordance with data signals and scan signals applying a voltage to first and second electrodes; a data driver adapted to receive image signals to generate the data signals and to transmit the data signals to the display portion; and a color controlling unit adapted to control a voltage of the first electrodes to correspond to the image signals and to correct the image signals to correspond to emission rates of the red, blue, and green pixels in accordance with a change in the voltage of the first electrodes so that the corrected image signals are transmitted to the data driver.

### CROSS-REFERENCE TO RELATED APPLICATION

This application claims priority to and the benefit of Korean Patent Application No. 10-2005-0086542, filed on Sep. 15, 2005, in the Korean Intellectual Property Office, the entire content of which is incorporated herein by reference.

### BACKGROUND

1. Field of the Invention

The present invention relates to an electron emission display device and a method of driving the same, and more particularly, to an electron emission display device capable of reducing or preventing non-uniformity in color from being generated in processes of controlling a gate voltage and a cathode voltage and a method of driving the same.

2. Discussion of Related Art

In general, electron emission devices used for electron emission display devices can be classified into electron emission devices in which hot cathode rays are used as electron sources and electron emission devices in which cold cathode rays are used as electron sources. The electron emission devices in which the cold cathodes are used include field emitter array (FEA) type electron emission devices, surface conduction emitter (SCE) type electron emission devices, metal-insulator-metal (MIM) type electron emission devices, metal-insulator-semiconductor (MIS) type electron emission devices, and ballistic electron surface emitting (BSE) type electron emission devices.

The FEA type electron emission device uses material having a low work function or a high β function as an electron emission source so that electrons are emitted under vacuum due to difference in electric fields. A device in which an electron emission source is formed of a pointed tip structure, carbon material, or nano material has been developed.

In the SCE type electron emission device, a conductive thin film is provided between two electrodes arranged on substrates to face each other and minute cracks are provided in the conductive thin film so that an electron emission unit is formed. In the SCE type electron emission device, a voltage is applied to the electrodes so that current flows to the surface of the conductive thin film and that electrons are emitted from the electron emission unit that is a minute gap.

In the MIM type and MIS type electron emission devices, electron emission units having MIM and MIS structures are formed. When a voltage is applied between two metals or metal and semiconductor with an dielectric layer interposed, electrons are emitted while moving and being accelerated from the metal or semiconductor having high electron potential toward the metal having low electron potential.

In the BSE type electron emission device, an electron supply layer formed of metal or semiconductor is formed on an ohmic electrode and an insulating layer and a metal thin film are formed on the electron supply layer so that electrons are emitted by applying a power source to the ohmic electrode and the metal thin film in accordance with a principle in which electrons are not scattered but travel when the size of semiconductor is reduced to be smaller than the mean free patch of the electrons in the semiconductor.

The above-described electron emission devices can be used in various fields and have recently been actively studied due to their advantages in that they operate by emission of cathode electrode lines (self light sources, high efficiency, high brightness, wide brightness regions, natural colors, high color purity, and wide view angles) like the CRTs and that they have high operation speed and wide operation temperature regions.

FIG. 1 illustrates a structure of a conventional electron emission display device. Referring to FIG. 1, the electron emission display device includes a display portion 10, a data driver 20, and a scan driver 30.

In the display portion 10, pixels are located in regions defined by the crossings (or intersections) between cathode electrodes C1, C2, . . . , and Cm and gate electrodes G1, G2, . . . , and Gn. Each of the pixels includes an electron emission unit of an electron emission device. Electrons emitted from the electron emission units and the cathode electrodes collide with anode electrodes so that phosphors emit light to display gray scale images. The gray levels of the displayed images vary in accordance with the values of input digital image signals. To control the gray levels displayed in accordance with the values of the digital image signals, a pulse width modulation method or a pulse amplitude modulation method may be used.

Here, carbon nanotubes (CNT) having a high self emission efficiency are used as the electron emission unit.

The data driver 20 is connected to the cathode electrodes C1, C2, . . . , and Cm to generate data signals and to transmit the generated data signals to the display portion 10 so that the display portion 10 emits light corresponding to the data signals.

The scan driver 30 is connected to the gate electrodes G1, G2, . . . , and Gn to generate scan signals and to transmit the generated scan signals to the display portion 10 so that the display portion 10 sequentially emits light using a line scan method, in units of horizontal lines, with uniform time period to display an entire image on the display portion 10. Therefore, the electron emission display device of FIG. 1 is a light emitting display device.

Here, when an image of high brightness is displayed, a large amount of current flows through the display portion 10 so that a large amount of load is applied to the display portion 10, thereby requiring a power source having high output. Therefore, the power consumption of the electron emission display device (or the light emitting display device) increases.

Also, when an image having low brightness is displayed, the brightness of the display portion 10 is reduced so that contrast may deteriorate.

### SUMMARY OF THE INVENTION

Accordingly, an embodiment of the present invention provides an electron emission display device capable of reducing or preventing non-uniformity in color from being generated due to difference in brightness characteristics of red, blue, and green light (or color) components in processes of controlling a cathode voltage and a gate voltage to correspond to the entire brightness of a display portion, and a method of driving the same.

In an embodiment of the present invention, there is provided an electron emission display device including: a display portion having a plurality of pixels adapted to emit light in accordance with data signals and scan signals applying a voltage to first electrodes and second electrodes, the plurality of pixels including red pixels, blue pixels, and green pixels; a data driver adapted to receive image signals to generate the data signals and to transmit the data signals to the display portion; a scan driver adapted to generate the scan signals and to transmit the scan signals to the display portion; and a color controlling unit adapted to control a voltage of the first electrodes to correspond to the image signals and to correct the image signals to correspond to emission rates of the red pixels, the blue pixels, and the green pixels in accordance with a change in the voltage of the first electrodes so that the corrected image signals are transmitted to the data driver.

According to another embodiment of the present invention, there is provided an electron emission display device including: a display portion having a plurality of pixels adapted to emit light in accordance with data signals and scan signals applying a voltage to first electrodes and second electrodes, the plurality of pixels including red pixels, blue pixels, and green pixels; a color controlling unit adapted to correct image signals using red, blue, and green correction coefficients associated with data signals adapted to display gray scale images and to determine the red correction coefficient corresponding to the red pixels, the blue correction coefficient corresponding to the blue pixels, and the green correction coefficient corresponding to the green pixels to correspond to a voltage of the first electrodes; a data driver adapted to control emission times of the red pixels, the blue pixels, and the green pixels using the corrected image signals output from the color controlling unit to display the gray scale images; and a scan driver adapted to generate the scan signals to transmit the scan signals to the display portion.

According to yet another embodiment of the present invention, there is provided a method of driving an electron emission display device including pixels adapted to generate data signals using image signals and to emit red, blue, and green light components in accordance with difference in a voltage between first electrodes and second electrodes corresponding to the data signals, the pixels including red pixels, blue pixels, and green pixels. The method includes: adding the image signals with each other to control a voltage of the first electrodes to correspond to the image signals added with each other; determining a red correction coefficient corresponding to the red pixels, a blue correction coefficient corresponding to the blue pixels, and a green correction coefficient corresponding to the green pixels; and correcting the image signals by the red, blue, and green correction coefficients to generate the data signals using the corrected image signals.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 illustrates a structure of a conventional electron emission display device;

FIG. 2 illustrates a structure of an electron emission display device according to an embodiment of the present invention;

FIG. 3 is a graph illustrating a change in brightness of a pixel of the electron emission display device illustrated in FIG. 2 in accordance with a voltage (or voltage level) of a gate electrode;

FIG. 4 illustrates a structure of a color controlling unit used for the electron emission display device of FIG. 2;

FIG. 5 illustrates a structure of a voltage controlling unit illustrated in FIG. 4;

FIG. 6 is a flowchart illustrating processes of generating data signals by an electron emission display device according to an embodiment of the present invention;

FIG. 7 is a perspective view illustrating a display portion of the electron emission display device illustrated in FIG. 2; and

FIG. 8 is a sectional view illustrating a section of the display portion of the electron emission display device illustrated in FIG. 2.

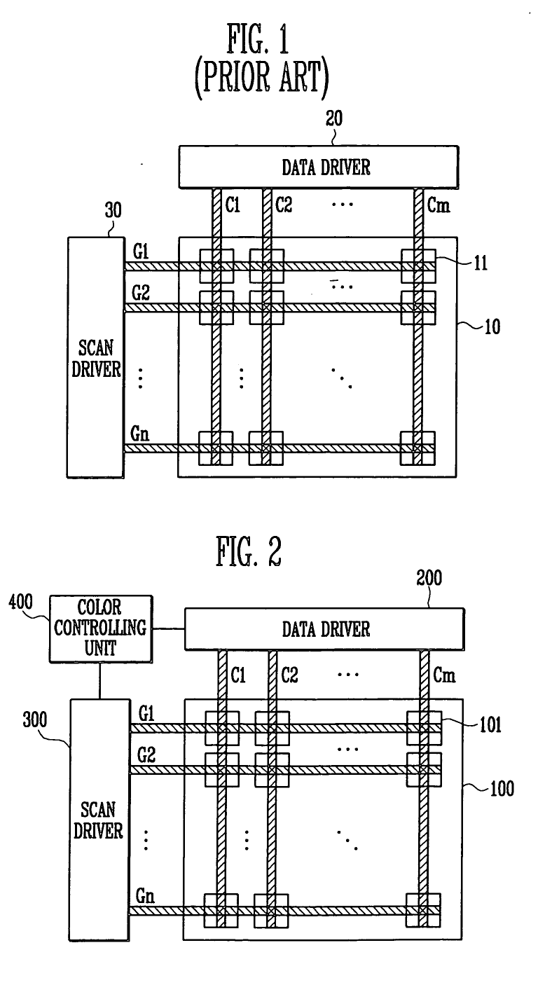

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

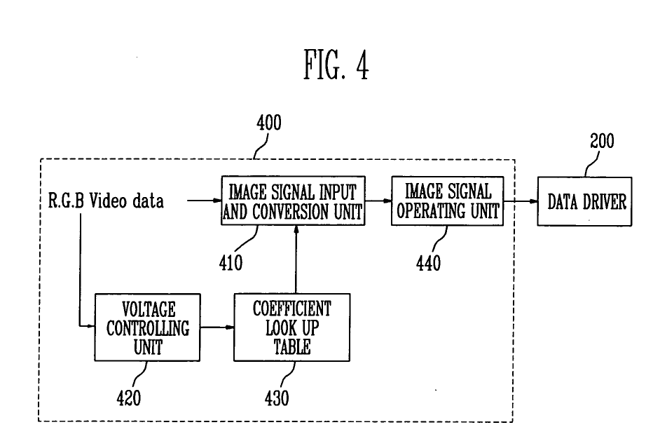

FIG. 2 illustrates a structure of an electron emission display device according to an embodiment of the present invention. FIG. 3 is a graph illustrating a change in brightness of a pixel of the electron emission display device illustrated in FIG. 2 in accordance with a voltage (or voltage level) of a gate electrode. Referring to FIGS. 2 and 3, the electron emission display device includes a display portion 100, a data driver 200, a scan driver 300, and a color controlling unit 400.

In the display portion 100, a plurality of cathode electrodes C1, C2, . . . , and Cm are arranged to extend in a column direction, a plurality of gate electrodes G1, G2, . . . and Gn are arranged to extend in a row direction, and electron emission units are located in regions defined by the crossings (or the intersections) between the cathode electrodes C1, C2, . . . , and Cm and the gate electrodes G1, G2, . . . , and Gn to form pixels 101. In other embodiments, the gate electrodes G1, G2, . . . , and Gn may be arranged to extend in the column direction and the cathode electrodes C1, C2, . . . , and Cm may be arranged to extend in the row direction. Hereinafter, it is assumed that the cathode electrodes C1, C2, . . . , and Cm are arranged to extend in the column direction and the gate electrodes G1, G2, . . . , and Gn are arranged to extend in the row direction. The display portion 100 reduces a difference in voltage between the gate electrodes G1, G2, . . . , and Gn and the cathode electrodes C1, C2, . . . , and Cm to reduce the brightness of each pixel when the number of pixels 101 that emit light with high brightness is relatively large and increases a difference in voltage between the gate electrodes G1, G2, . . . , and Gn and the cathode electrodes C1, C2, . . . , and Cm to increase the brightness of each pixel when the number of pixels 101 that emit light with high brightness is relatively small. Therefore, when the number of pixels 101 that emit with high brightness is relatively large, the brightness of the display portion 100 is reduced so that power consumption is reduced. When the number of pixels 101 that emit light with high brightness is relatively small, the brightness of the pixels that emit light with high brightness increases so that a difference in brightness between the pixels that emit light with high brightness and the pixels that emit light with low brightness is large, thereby improving contrast. Also, when difference in voltage between the gate electrodes G1, G2, . . . , and Gn and the cathode electrodes C1, C2, . . . and Cm changes, a change in brightness of each of red, blue, and green pixels varies in accordance with the deviation in emission efficiencies of the red, blue, and green pixels so that non-uniformity in color may be generated.

The data driver 200 generates data signals using image signals and is connected to the cathode electrodes C1, C2, . . . , and Cm to transmit the data signals to the cathode electrodes C1, C2, . . . , and Cm. The data driver 200 determines the emission time of the pixels 101 located in the regions defined by the crossings (or the intersections) between the selected gate electrodes G1, G2, . . . , and Gn and cathode electrodes C1, C2, . . . , and Cm by using the data signals.

The scan driver 300 is connected to the gate electrodes G1, G2, . . . , and Gn to select one or more of the gate electrodes G1, G2, . . . , and Gn arranged in the row direction so that scan signals are transmitted to the pixels 101 connected to the selected gate electrodes G1, G2 .. . . , and Gn.

The color controlling unit 400 controls image data in accordance with the emission rates of the pixels that emit red, blue, and green light components so that the brightness compensation ranges of the red, blue, and green pixels vary to reduce or prevent non-uniformity in color. The brightness of the red, blue, and green pixels changes in accordance with a change in voltage difference between the cathode electrodes and the gate electrodes. Although the voltages of the cathode electrodes and the gate electrodes are applied to the red, blue, and green pixels, when a difference in voltage between the cathode electrodes and the gate electrodes varies, the ratio at which the brightness of each of the red, blue, and green pixels increases varies in accordance with the emission rates of the red, blue, and green pixels as illustrated in FIG. 3. Therefore, when the emission rates of the red, blue, and green pixels are controlled in accordance with a conventional white balance control method, white balance is not maintained. Therefore, in one embodiment of the present invention, the emission rates of the red, blue, and green pixels are controlled to correspond to a difference in voltage between the cathode electrodes and the gate electrodes of the red, blue, and green pixels so that the white balance is maintained. In FIG. 3, dotted lines are graphs illustrating initial brightness increase rates of the red, blue, and green pixels and solid lines are graphs illustrating brightness increase rates of the red, blue, and green pixels after the difference in voltage between the cathode electrodes and the gate electrodes is controlled.

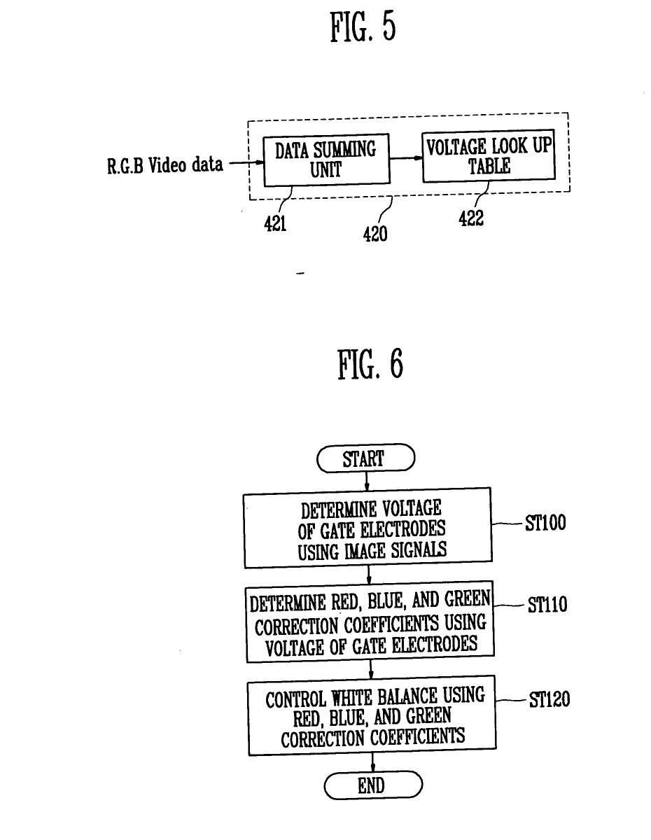

FIG. 4 illustrates the structure of the color controlling unit 400 used for the electron emission display device of FIG. 2. Referring to FIG. 4, the color controlling unit 400 includes an image signal input and conversion unit 410, a voltage controlling unit 420, a coefficient look up table 430, and an image signal operating unit 440.

The image signal input and conversion unit 410 receives image signals and corrects the received image signals to output the corrected image signals. The red, blue, and green image signals are digital signals that are used to display gray scale values and are corrected by multiplying the image signals with correction coefficients for brightness deviation in accordance with a change in voltages of the cathode electrodes and the gate electrodes from the coefficient look up table 430. The image signal input and conversion unit 410 corrects the input image signals to transmit the corrected image signals to the image signal operating unit 440.

The voltage controlling unit 420 controls the voltage of the gate electrodes in accordance with the magnitude of the input image signals so that a difference in voltage between the gate electrodes and the cathode electrodes changes. The number of pixels that emit light with high brightness is relatively large when the magnitude of the image signals input to the display portion 100 is relatively large, and the number of pixels that emit light with high brightness is relatively small when the magnitude of the image signals input to the display portion 100 is relatively small. Therefore, after the voltage of the gate electrodes has been stored to correspond to the magnitude of the image signals and the magnitude of the image signals has been determined, a voltage control signal corresponding to the changed voltage of the gate electrodes is transmitted to the coefficient look up table 430. Here, the magnitude of the image signals refers to the sum of the image signals input in the time period (one horizontal period) of one frame.

The coefficient look up table 430 stores red, blue, and green correction coefficients corresponding to each voltage of the gate electrodes, receives the voltage control signal from the voltage controlling unit 420, selects a correction coefficient corresponding to the voltage control signal, and transmits the correction coefficient to the image signal input and conversion unit 410. Therefore, when the voltage of the gate electrodes is changed, a correction coefficient corresponding to the changed voltage of the gate electrodes is transmitted to the image signal input and conversion unit 410.

The image signal operating unit 440 corrects the red, blue, and green image signals using the correction coefficients and divides the corrected red, blue, and green image signals by the correction coefficients so that the red image signal is divided by the largest correction coefficient among the red correction coefficients, that the blue image signal is divided by the largest correction coefficient among the blue correction coefficients, and that the green image signal is divided by the largest correction coefficient among the green correction coefficients to generate red, blue, and green brightness change ratios.

Therefore, the red image signal is corrected in accordance with the red brightness change ratio, the blue image signal is corrected in accordance with the blue brightness change ratio, and the green image signal is corrected in accordance with the green brightness change ratio. The corrected image signals are transmitted to the data driver 200 so that the data driver 200 controls pulse width in accordance with the corrected image signals to display gray scale images.

Therefore, each of the red, blue, and green image signals corrects brightness that non-linearly increases in accordance with increase in voltages of the gate electrodes and the cathode electrodes by each of the red, blue, and green emission efficiencies to control the white balance.

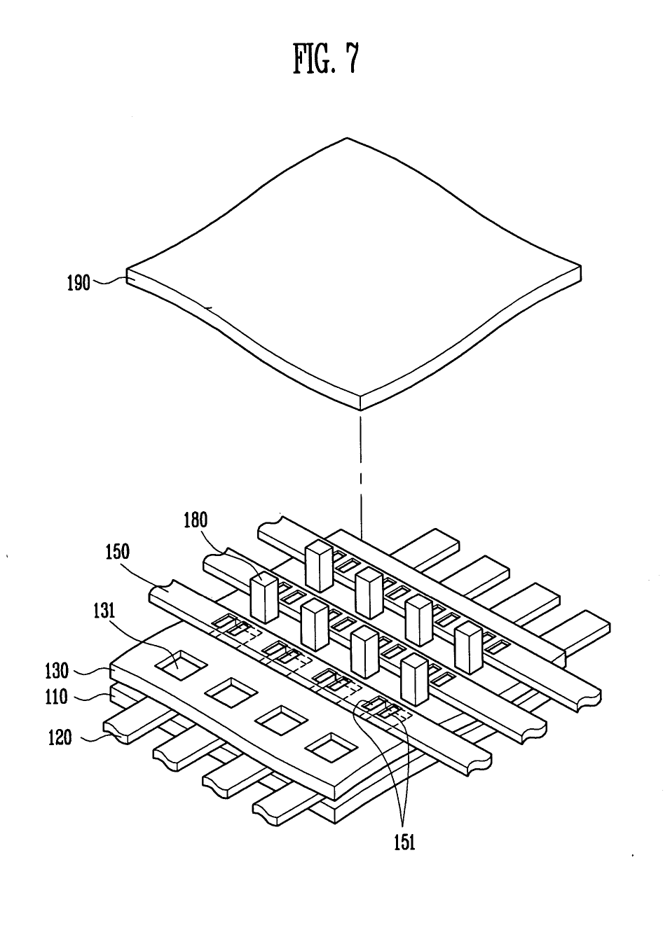

FIG. 5 illustrates a structure of the voltage controlling unit 420 illustrated in FIG. 4. Referring to FIG. 5, the voltage controlling unit 420 includes a data summing unit 421 and a voltage look up table 422.

The data summing unit 421 determines the sum of the image signals input in the time period of one frame. The magnitude of the image signals is large when high gray levels are displayed and is small when low gray levels are displayed. Therefore, it is determined that the number of pixels that emit light with high brightness is large when the sum of the image signals is large and that the number of pixels that emit light with high brightness is small when the sum of the image signals is small.

The voltage look up table 422 designates the voltage of the gate electrodes corresponding to the sum of the image signals so that the voltage of the gate electrodes corresponds to the sum of the image signals on a one-to-one basis. Therefore, when the sum of the image signals is calculated by the data summing unit, the voltage of the gate electrodes corresponding to the sum of the image signals is extracted and the extracted voltage of the gate electrodes is transmitted to the coefficient look up table 430. The coefficient look up table 430 determines the correction coefficient corresponding to the voltage of the gate electrodes determined by the voltage look up table 422.

FIG. 6 is a flowchart illustrating processes of generating data signals by an electron emission display device according to an embodiment of the present invention.

Referring to FIG. 6, in the first step (ST100), image signals input during the time period of one frame are added with each other, and the voltage of the gate electrodes corresponds to the magnitude of the sum of the image signals. The voltage of the gate electrodes corresponding to the sum of the image signals input during the time period of one frame is stored in the voltage look up table 422 so that the voltage of the gate electrodes is determined by the voltage look up table 422 when the image signals are added with each other.

In the second step (ST110), red, blue, and green correction coefficients corresponding to the voltage of the gate electrodes are determined by the coefficient look up table 430 so that the correction coefficients are applied to the image signals to correct the image signals. Here, the red, blue, and green correction coefficients corresponding to the voltage of the gate electrodes are stored in the coefficient look up table 430. The image signals are corrected by multiplying the image signals by the respective correction coefficients and then, dividing the image signals corrected by the correction coefficients by the largest correction coefficients among the stored red, blue, and green correction coefficients so that the image signals are corrected in a uniform ratio.

In the third step (ST120), the emission time of the red, blue, and green pixels is controlled by the image signals corrected by the multiplication and division operations so that the white balance is controlled in accordance with the emission time.

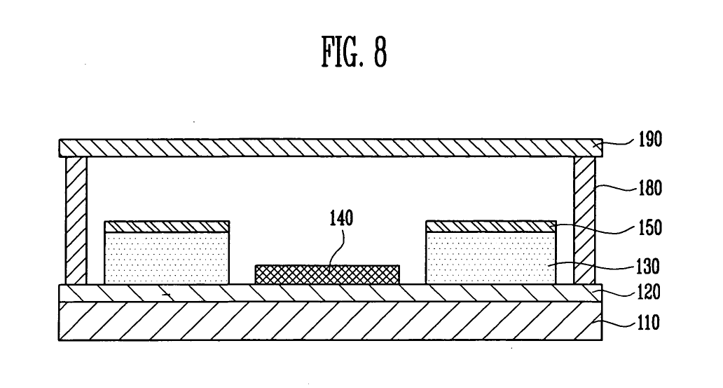

FIG. 7 is a perspective view illustrating a display portion of the electron emission display device illustrated in FIG. 2. FIG. 8 is a section of the display portion of the electron emission display device illustrated in FIG. 2. Referring to FIGS. 7 and 8, the electron emission display device includes a bottom substrate 110, a top substrate 190, and spacers 180. Cathode electrodes 120, an insulating layer 130, electron emission units 140, and gate electrodes 150 are formed on the bottom substrate 110. A front surface substrate, anode electrodes, and a fluorescent layer are formed on the top substrate 190.

The cathode electrodes 120 are formed on the bottom substrate 110 in stripes and the insulating layer 130 has a plurality of first grooves 131 to expose parts of the cathode electrodes 120 and the emission units 140 positioned on the exposed parts of the cathode electrodes 120. The gate electrodes 150 are formed on the insulating layer 130. A plurality of second grooves 151 of a uniform size are formed in the gate electrodes 150 and the second grooves 151 are formed on the first grooves 131. The electron emission units 140 are positioned on the cathode electrodes 120 in the regions where the first grooves 131 coincide with the second grooves 151.

A glass or silicon substrate is used as the bottom substrate 110. When the electron emission units 140 are formed using a carbon nanotube (CNT) paste through a rear surface light exposing process, the bottom substrate 110 may be formed by a transparent substrate such as the glass substrate.

The cathode electrodes 120 supply the data signals or the scan signals applied from a data driver (e.g., the data driver 200 of FIG. 2) or a scan driver (e.g., the scan driver 300 of FIG. 2) to the electron emission units 140. The cathode electrodes 120 are formed of indium tin oxide (ITO).

The insulating layer 130 is formed on both the bottom substrate 110 and the cathode electrodes 120 to electrically insulate the cathode electrodes 120 from the gate electrodes 150.

The gate electrodes 150 are arranged on the insulating layer 130 in a shape (e.g., a predetermined shape, such as stripes) to cross (or intersect) the cathode electrodes 120 and to supply the data signals or the scan signals applied from the data driver 200 or the scan driver 300 to the pixels. The gate electrodes 150 are formed of at least one conductive metal selected from metals having high conductivity such as Au, Ag, Pt, Al, and Cr and alloys thereof.

The electron emission units 140 are electrically connected to the cathode electrodes 120 exposed by the first grooves 131 of the insulating layer 130 and, in one embodiment, are formed of materials that emit electrons when an electrical field is applied, such as carbon based material or nanometer (nm) sized material (e.g., carbon nanotube, graphite, graphite nanofiber, diamond-like carbon, C₆₀, silicon nanowire, and combinations thereof).

The top substrate 190 includes the fluorescent layer so that light is emitted when electrons collide with the fluorescent layer and includes the anode electrodes so that electrons emitted from the electron emission units 140 collide with the top substrate 190.

The spacers 180 ensure that the bottom substrate 110 and the top substrate 190 are separated from each other by a uniform distance.

In view of the foregoing, an electron emission display device of an embodiment of the present invention and/or a method of driving the same can reduce or prevent non-uniformity in color from being generated in accordance with change in difference in voltage between the gate electrodes and the cathode electrodes and/or can reduce brightness when needed to reduce power consumption.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An electron emission display device comprising:
a display portion having a plurality of pixels adapted to emit light in accordance with data signals and scan signals applying a voltage to first electrodes and second electrodes, the plurality of pixels comprising red, blue, and green pixels;
a data driver adapted to receive image signals to generate the data signals and to transmit the data signals to the display portion;
a scan driver adapted to generate the scan signals and to transmit the scan signals to the display portion; and
a color controlling unit adapted to control the voltage of the first electrodes to correspond to the image signals and to correct the image signals to correspond to an emission rate of the red pixels, an emission rate of the blue pixels, and an emission rate of the green pixels in accordance with a change in the voltage of the first electrodes so that the corrected image signals are transmitted to the data driver.

2. The electron emission display device as claimed in claim 1, wherein the color controlling unit comprises:
a coefficient look up table adapted to store a red correction coefficient corresponding to the emission rate of the red pixels, a blue correction coefficient corresponding to the emission rate of the blue pixels, and a green correction coefficient corresponding to the emission rate of the green pixels to correspond to the change in the voltage of the first electrodes;
an image signal input unit adapted to correct the image signals using the red, blue, and green correction coefficients; and
a voltage controlling unit adapted to control the voltage of the first electrodes and to transmit at least one voltage control signal corresponding to the voltage of the first electrodes to the coefficient look up table.

3. The electron emission display device as claimed in claim 2, wherein the coefficient look up table is adapted to store the red, blue, and green correction coefficients to correspond to the at least one voltage control signal and to control the emission rates by using the red, blue, and green correction coefficients.

4. The electron emission display device as claimed in claim 2, wherein the red, blue, and green correction coefficients are determined by a change in brightness in accordance with the voltage of the first electrodes when gray scale images are displayed.

5. The electron emission display device as claimed in claim 2, wherein the color controlling unit further comprises an image signal operating unit adapted to receive the corrected image signals and to divide the corrected image signals by respective maximum values of the red, blue, and green correction coefficients.

6. The electron emission display device as claimed in claim 2, wherein the data driver is adapted to control the emission times of the red pixels, the blue pixels, and the green pixels through the red, blue, and green correction coefficients to display gray scale images.

7. The electron emission display device as claimed in claim 2, wherein the voltage controlling unit comprises:
a data summing unit adapted to add the image signals input in a time period of one frame with each other to generate image data; and
a voltage look up table adapted to store a voltage corresponding to the image data obtained by the data summing unit.

8. The electron emission display device as claimed in claim 1, wherein the data driver is adapted to control the emission times of the red pixels, the blue pixels, and the green pixels through red, blue, and green correction coefficients, respectively, to display gray scale images.

9. An electron emission display device comprising:
a display portion having a plurality of pixels adapted to emit light in accordance with data signals and scan signals applying a voltage to first electrodes and second electrodes, the plurality of pixels comprising red pixels, blue pixels, and green pixels;
a color controlling unit adapted to correct image signals using red, blue, and green correction coefficients associated with data signals adapted to display gray scale images and to determine the red correction coefficient corresponding to the red pixels, the blue correction coefficient corresponding to the blue pixels, and the green correction coefficient corresponding to the green pixels to correspond to the voltage of the first electrodes;
a data driver adapted to control emission times of the red pixels, the blue pixels, and the green pixels using the corrected image signals output from the color controlling unit to display the gray scale images; and
a scan driver adapted to generate the scan signals to transmit the scan signals to the display portion.

10. The electron emission display device as claimed in claim 9, wherein the color controlling unit further comprises an image signal operating unit adapted to divide the image signals by respective maximum values of the red, blue, and green correction coefficients.

11. The electron emission display device as claimed in claim 9, wherein the color controlling unit comprises:
a coefficient look up table adapted to store the red correction coefficient corresponding to the red pixels, the blue correction coefficient corresponding to the blue pixels, and the green correction coefficient corresponding to the emission rate of the green pixels to correspond to the voltage of the first electrodes.

12. The electron emission display device as claimed in claim 9, wherein the color controlling unit is adapted to detect the voltage of the first electrodes to transmit the voltage of the first electrodes to the coefficient look up table.

13. The electron emission display device as claimed in claim 12, wherein the voltage controlling unit comprises:
a data summing unit adapted to add the image signals input in a time period of one frame with each other to generate image data; and
a voltage look up table adapted to store a voltage corresponding to the image data obtained by the data summing unit.

14. A method of driving an electron emission display device comprising pixels adapted to generate data signals using image signals and to emit red, blue, and green light components in accordance with a difference in a voltage between first electrodes and second electrodes corresponding to the data signals, the pixels comprising red pixels, blue pixels, and green pixels, the method comprising:
adding the image signals with each other to control a voltage of the first electrodes to correspond to the image signals added with each other;
determining a red correction coefficient corresponding to the red pixels, a blue correction coefficient corresponding to the blue pixels, and a green correction coefficient corresponding to the green pixels; and
correcting the image signals by the red, blue, and green correction coefficients to generate the data signals using the corrected image signals.

15. The method as claimed in claim 14, wherein the emission times of the red pixels, the blue pixels, and the green pixels are controlled by the red, blue, and green correction coefficients to display gray scale images.

16. The method as claimed in claim 14, wherein the correction coefficients are determined by a coefficient look up table.

17. The method as claimed in claim 14, wherein the correction coefficient is formed by at least one of the data signals through a ratio of a brightness in accordance with a first voltage of the first electrodes to a brightness in accordance with a second voltage of the first electrodes.

18. The method as claimed in claim 14, wherein the voltage of the first electrodes is controlled by summing the image signals input in a time period of one frame.

19. The method as claimed in claim 18, wherein a difference in voltage between the first electrodes and the second electrodes is relatively small when the sum of the image signals is relatively large and the difference is relatively large when the sum of the image signals is relatively small.

20. The method as claimed in claim 14, wherein a time period for which the voltage of the first electrodes is maintained is controlled by the data signals.

21. The method as claimed in claim 14, wherein a difference in voltage between the first electrodes and the second electrodes is relatively small when a sum of the image signals is relatively large and the difference is relatively large when the sum of the image signals is relatively small.
